(19) United States
(12) Patent Application Publication
(10) Pub. No.: US 2013/0256298 A1
(43) Pub. Date: Oct. 3, 2013

(54) HEATER AND GLOW PLUG PROVIDED WITH SAME

(71) Applicant: Kotaro Taimura, Krishima-shi (JP)

(72) Inventor: Kotaro Taimura, Krishima-shi (JP)

(21) Appl. No.: 13/825,940

(22) PCT Filed: Mar. 23, 2011
(86) PCT No.: PCT/JP2011/056992

§ 371 Date: Jun. 18, 2013

(30) Foreign Application Priority Data
Sep. 27, 2010 (JP) 2010-215552

(51) Int. Cl. H05B 3/02

(52) U.S. Cl. CPC H05B 3/02
USPC 219/552

(57) ABSTRACT

A heater includes an insulating base body; a resistor embedded in the insulating base body; and a lead embedded in the insulating base body and including one end connected to the resistor, and a terminal portion at another end thereof which is exposed from a surface of the insulating base body. The lead further includes a bent portion bent toward the terminal portion, and an aspect ratio in at least one cross section of the bent portion is larger than an aspect ratio in another cross section of the bent portion, the another cross section being positioned closer to the terminal portion than the at least one cross section of the bent portion.

### TECHNICAL FIELD

The present invention relates to a heater which is utilized as, for example, a heater for ignition or flame detection in a combustion-type vehicle-mounted heating device, a heater for ignition for various combustion equipment such as an oil fan heater, a heater for a glow plug of an automobile engine, a heater for various sensors such as an oxygen sensor, a heater for heating of measuring equipment, and a glow plug provided with such a heater.

### BACKGROUND ART

As a heater for a glow plug of an automobile engine, for example, there has been known a heater which includes: an insulating base body; a resistor which is embedded in the insulating base body; and a lead embedded in the insulating base body, the lead having one end connected to the resistor, and having a terminal portion at another end thereof which is exposed from a surface of the insulating base body, wherein the lead has a bent portion bent toward the terminal portion (see Patent Literature 1, for example).

In the above-mentioned constitution, in general, the terminal portion of the lead has a circular shape, and a cross-sectional shape of the bent portion of the lead also has a circular shape in the same manner as the shape of the terminal portion.

### CITATION LIST

### Patent Literature

Patent Literature 1: Japanese Unexamined Patent Publication JP-A 2006-258417

### SUMMARY OF INVENTION

### Technical Problem

Recently, there arises a demand for a heater whose temperature can be elevated more rapidly and hence, it has become necessary to increase power (inrush power) introduced to the heater from the terminal portion so as to allow a large electric current to flow into a resistor at the time of starting (at the time of starting an engine).

Here, in an attempt to increase inrush power in the above-mentioned heater, a load of inrush power is concentrated on an outer side (an A2′ side in FIG. 2) of a bent portion of a lead in the vicinity of the center of a curve (an area in the vicinity of a cross section taken along the line A2-A2′ shown in FIG. 2) so that a portion of the bent portion of the lead in the vicinity of the center of the curve is locally expanded due to local heat generation, and a stress is concentrated on an interface between the lead and an insulating base body at such a locally expanded portion thus giving rise to a drawback that microcracks are generated in the interface.

The invention has been made in view of the above-mentioned drawback, and it is an object of the invention to provide a heater having high reliability and high durability in which generation of microcracks due to stress concentration derived from local expansion of a bent portion of a lead is suppressed even when a large electric current flows into the bent portion at the time of sharply elevating a temperature of the heater, and a glow plug provided with the heater.

### Solution to Problem

The invention provides a heater including: an insulating base body; a resistor embedded in the insulating base body; and a lead embedded in the insulating base body, and including one end connected to the resistor, and a terminal portion at another end thereof which is exposed from a surface of the insulating base body, wherein the lead further includes a bent portion bent toward the terminal portion, an aspect ratio in at least one cross section of the bent portion being larger than an aspect ratio in another cross section of the bent portion, the another cross section being positioned closer to the terminal portion than the at least one cross section of the bent portion.

The invention also provides a glow plug including the heater having the above-mentioned constitution, and a metal holder which is electrically connected to the terminal portion of the lead and holds the heater.

### Advantageous Effects of Invention

According to the heater of the invention, by providing the portion on which a load of inrush power is liable to be concentrated besides an outer side (A2′ side) of a bent portion A in the vicinity of the center of a curve (an area in the vicinity of a cross section taken along the line A2-A2′ shown in FIG. 2) on which a load of inrush power is liable to be concentrated, the load of the inrush power can be dispersed to other portions from the outer side (A2′ side) of the bent portion in the vicinity of the center of the curve (the area in the vicinity of a cross section taken along the line A2-A2′ shown in FIG. 2) whereby the generation of microcracks on an interface between the lead and the insulating base body can be suppressed.

### BRIEF DESCRIPTION OF DRAWINGS

FIG. 1 is a longitudinal cross-sectional view showing one embodiment of a heater of the invention;

FIG. 2(a) is an enlarged view of a bent portion A of a lead shown in FIG. 1, FIG. 2(b) is a cross-sectional view taken along the line A1-A1′ shown in FIG. 2(a), FIG. 2(c) is a cross-sectional view taken along the line A2-A2′ shown in FIG. 2(a), and FIG. 2(d) is a cross-sectional view taken along the line A3-A3′ shown in FIG. 2(a);

FIG. 3(a) is an enlarged view of a bent portion A of a lead according to another embodiment of the heater of the invention, FIG. 3(b) is a cross-sectional view taken along the line A1-A1′ shown in FIG. 3(a), FIG. 3(c) is a cross-sectional view taken along the line A2-A2′ shown in FIG. 3(a), and FIG. 3(d) is a cross-sectional view taken along the line A3-A3′ shown in FIG. 3(a); and

FIG. 4(a) is an enlarged view of a bent portion A of a lead according to still another embodiment of the heater of the invention, FIG. 4(b) is a cross-sectional view taken along the line A1-A1′ shown in FIG. 4(a), FIG. 4(c) is a cross-sectional view taken along the line A2-A2′ shown in FIG. 4(a), and FIG. 4(d) is a cross-sectional view taken along the line A3-A3′ shown in FIG. 4(a).

### DESCRIPTION OF EMBODIMENTS

An embodiment of a heater of the invention is explained in detail in conjunction with drawings.

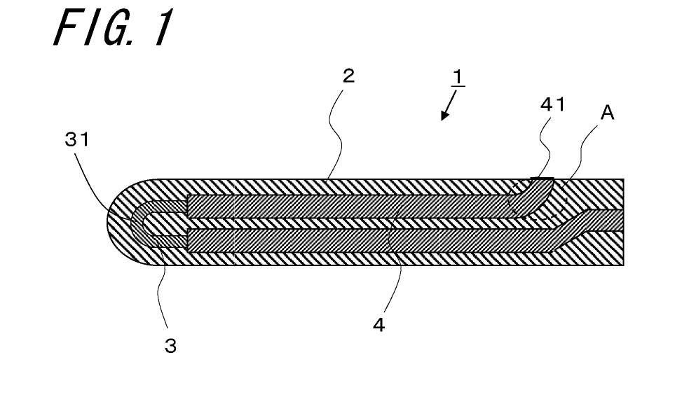

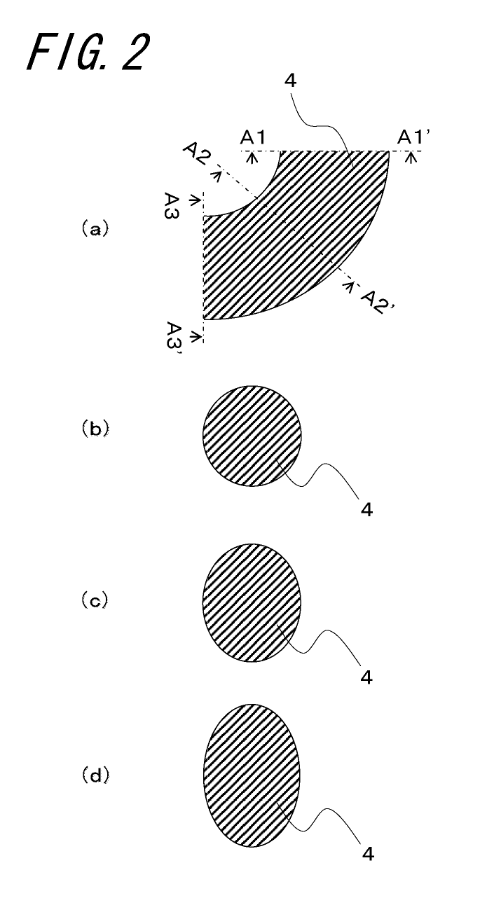

FIG. 1 is a longitudinal cross-sectional view showing one embodiment of the heater of the invention, FIG. 2(a) is an enlarged view of a bent portion A of a lead shown in FIG. 1, FIG. 2(b) is a cross-sectional view taken along the line A1-A1′ shown in FIG. 2(a), FIG. 2(c) is a cross-sectional view taken along the line A2-A2′ shown in FIG. 2(a), and FIG. 2(d) is a cross-sectional view taken along the line A3-A3′ shown in FIG. 2(a).

A heater 1 shown in FIG. 1 includes an insulating base body 2, a resistor 3 embedded in the insulating base body 2, and a lead 4 embedded in the insulating base body 2, the lead 4 having one end connected to the resistor 3, and having a terminal portion 41 at another end thereof which is exposed from a surface of the insulating base body 2. The lead 4 has a bent portion A bent toward the terminal portion 41, and an aspect ratio in at least one cross section of the bent portion A is larger than an aspect ratio in another cross section of the bent portion A, the another cross section being positioned closer to the terminal portion 41 than the at least one cross section of the bent portion A.

The insulating base body 2 of the heater 1 according to this embodiment is formed into a rod shape, for example. The resistor 3 and the lead 4 are embedded in the insulating base body 2. Here, the insulating base body 2 is preferably made of ceramics. Because of being made of ceramics, it is possible to provide the heater 1 which exhibits high reliability when a temperature of the heater 1 is sharply elevated. To be more specific, as a material of the insulating base body 2, ceramics having an electrical insulating performance such as oxide ceramics, nitride ceramics or carbide ceramics can be exemplified. Particularly, the insulating base body 2 is preferably made of silicon nitride ceramics. This is because silicon nitride which silicon nitride ceramics contains as a main component thereof is excellent in terms of high strength, high toughness, high insulation property and heat resistance. The insulating base body 2 made of silicon nitride ceramics can be obtained in such a manner that, for example, 3 to 12 mass % of rare earth element oxide such as Y₂O₃, Yb₂O₃ or Er₂O₃ which is provided as a sintering aid, 0.5 to 3 mass % of Al₂O₃, and 1.5 to 5 mass % of SiO₂ in terms of an amount of SiO₂ contained in a sintered body are mixed into silicon nitride which is the main component, for example, the mixture is formed into a predetermined shape and, thereafter, the mixture is subjected to hot press firing at a temperature of 1650 to 1780° C. A length of the insulating base body 2 is set to 20 to 50 mm, for example, and a diameter of the insulating base body 2 is set to 3 to 5 mm.

Here, when the insulating base body 2 which is made of silicon nitride ceramics is used, it is preferable to mix and disperse MoSiO₂, WSi₂ or the like into silicon nitride ceramics. In this case, it is possible to make a thermal expansion coefficient of silicon nitride ceramics which is a base material approximate a thermal expansion coefficient of the resistor 3, thus enhancing the durability of the heater 1.

The resistor 3 which is embedded in the insulating base body 2 has a folded shape with respect to a shape of a longitudinal cross section, and a portion of the resistor 3 in the vicinity of an intermediate point of the folded shape forms a heat-generating portion 31 which generates heat the most. This resistor 3 is embedded in a distal end side of the insulating base body 2, and a distance between a distal end of the resistor 3 (in the vicinity of the center of the folded shape) and a rear end of the resistor 3 (an end portion joined to the lead) is set to 2 to 10 mm, for example. Here, the resistor 3 may be constituted so as to have any transverse cross-sectional shape such as a circular shape, an elliptical shape, or a rectangular shape and, usually, a cross-sectional area of the resistor 3 is set to be smaller than a cross-sectional area of the lead 4 described later.

As a material for forming the resistor 3, a material which contains carbide, nitride, silicide or the like of W, Mo, Ti or the like as a main component can be used. When the insulating base body 2 is made of silicon nitride ceramics, from a viewpoint that a difference in thermal expansion coefficient between the resistor 3 and the insulating base body 2 is small, from a viewpoint that the resistor 3 exhibits high heat resistance and from a viewpoint that the resistor 3 exhibits small specific resistance, tungsten carbide (WC) is excellent as the material of the resistor 3 among the above-mentioned materials. Further, when the insulating base body 2 is made of silicon nitride ceramics, it is preferable that the resistor 3 contains WC which is an inorganic conductive material as a main component, and the content of silicon nitride to be added to WC is set to 20 mass % or more. For example, in the insulating base body 2 made of silicon nitride ceramics, a conductive component which forms the resistor 3 has a thermal expansion coefficient larger than a thermal expansion coefficient of silicon nitride and hence, the conductive component is usually in a state where a tensile stress is applied to the conductive component. To the contrary, by adding silicon nitride into the resistor 3, a thermal expansion coefficient of the resistor 3 is made to approximate a thermal expansion coefficient of the insulating base body 2 and hence, stress caused by the difference in thermal expansion coefficient between the insulating body 2 and the resistor 3 at the time of elevating or lowering a temperature of the heater 1 can be alleviated. Further, when the content of silicon nitride contained in the resistor 3 is 40 mass % or less, a resistance value of the resistor 3 can be made relatively small and stable. Accordingly, it is preferable that the content of silicon nitride contained in the resistor 3 falls within a range of from 20 mass % to 40 mass %. It is more preferable that the content of silicon nitride falls within a range of from 25 mass % to 35 mass %. As an additive to be added into the resistor 3 in the same manner as silicon nitride, 4 mass % to 12 mass % of boron nitride may be added into the resistor 3 in place of silicon nitride.

The lead 4 embedded in the insulating base body 2 has one end connected to the resistor 3 and has the terminal portion 41 at the another end thereof which is exposed from the surface of the insulating base body 2. To be more specific, the leads 4 are respectively joined to both end portions of the resistor 3 which has a folded shape from one end thereof to the other end thereof. Further, one lead 4 is connected to one end of the resistor 3 at one end thereof and is exposed from a side surface of the insulating base body 2 at a position close to a rear end of the insulating base body 2 at the another end thereof. Further, the other lead 4 is connected to the other end of the resistor 3 at one end thereof and is exposed from a rear end portion of the insulating base body 2 at the another end thereof.

The lead 4 is formed using substantially the same material as the resistor 3, for example, and by making a cross-sectional area of the lead 4 larger than a cross-sectional area of the resistor 3 or by setting the content of a material for forming the insulating base body 2 in the lead 4 to be smaller than the content of the material for forming the insulating base body 2 in the resistor 3, a resistance value per unit length of the lead 4 is made small. Particularly, from a viewpoint that the difference in thermal expansion coefficient between the lead 4 and the insulating base body 2 is small, from a viewpoint that the lead 4 exhibits high heat resistance and from a viewpoint that the lead 4 exhibits small specific resistance, WC is preferable as the material for forming the lead 4. Further, it is preferable that the lead 4 contains WC which is an inorganic conductive material as a main component, and silicon nitride is added into WC such that the content of silicon nitride becomes 15 mass % or more. Along with the increase of the content of silicon nitride, it is possible to make a thermal expansion coefficient of the lead 4 approximate a thermal expansion coefficient of silicon nitride for forming the insulating base body 2. Further, when the content of silicon nitride is 40 mass % or less, a resistance value of the lead 4 is made small and becomes stable. Accordingly, it is preferable that the content of silicon nitride is set to a value which falls within a range of from 15 mass % to 40 mass %. It is more preferable that the content of silicon nitride is set to a value which falls within a range of from 20 mass % to 35 mass %.

Further, the lead 4 (the lead 4 which is connected to one end of the resistor 3 at one end thereof and is exposed from the side surface of the insulating base body 2 at a position close to the rear end of the insulating base body 2 at the another end thereof) has a bent portion A bent toward the terminal portion 41, and an aspect ratio (longitudinal/lateral ratio) in at least one cross section of the bent portion A is larger than an aspect ratio in another cross section (cross-sectional view taken along the line A1-A1′ shown in FIG. 2) of the bent portion A, the another cross section being positioned closer to the terminal portion 41 than the at least one cross section of the bent portion A. Here, a portion of the lead 4 which is exposed from the side surface of the insulating base body 2 at a position close to the rear end of the insulating base body 2 is the terminal portion 41, and the bent portion A means a bent portion of the lead 4 from a portion in the vicinity of the terminal portion 41 to a straight portion which extends in the longitudinal direction of the rod-shaped insulating base body 2. Further, the longitudinal direction of the aspect ratio (longitudinal/lateral ratio) is a direction of an axis perpendicular to a plane parallel to a direction of bending of the bent portion A (plane including a central axis of the bent portion A) (a direction perpendicular to a surface of the paper on which FIG. 1 is drawn).

Here, in FIG. 2(b) to FIG. 2(d), the bent portion A is formed such that an aspect ratio (longitudinal/lateral ratio) in the cross section of the bent portion A gradually becomes larger as a distance from the terminal portion 41 becomes longer. That is, in FIG. 2(b) which is a cross-sectional view of a portion of the bent portion A in the vicinity of the terminal portion 41 taken along the line A1-A1′, the bent portion A has an approximately circular cross section. In FIG. 2(c) which is a cross-sectional view of a portion of the bent portion A in the vicinity of the center of a curve of the bent portion A taken along the line A2-A2′, the bent portion A has an elliptical cross section having a major axis in the direction perpendicular to a plane parallel to the direction of bending of the bent portion A (a plane including a central axis of the bent portion A) (a direction perpendicular to a surface of the paper). In FIG. 2(d) which is a cross-sectional view of a portion in the vicinity of a finish end of the bent portion A remote from the terminal portion 41 taken along the line A3-A3′, the bent portion A has an elliptical cross section having a major axis greater than the major axis of the elliptical cross-sectional shape shown in FIG. 2(c) taken along the line A2-A2′.

There is a tendency that a load of inrush power which flows into the lead 4 from the terminal portion 41 is increased at an outer side (A2′ side) of the bent portion A in the vicinity of the center of a curve in cross section of the bent portion A (an area in the vicinity of a cross section taken along the line A2-A2′ shown in FIG. 2). On the other hand, in general, when a cross-sectional shape is a circular shape, a load of inrush power in the radial direction is dispersed approximately uniformly with respect to any angles within 360°. However, when a shape of the cross section is a shape having a major axis and a minor axis, there is a tendency that a load of inrush power is applied to an area in the vicinity of a major-axis-side outer periphery. Accordingly, by setting an aspect ratio in at least one cross section of the bent portion A larger than an aspect ratio in another cross section (cross-sectional view taken along the line A1-A1′ shown in FIG. 2) of the bent portion A, the another cross section being positioned closer to the terminal portion 41 than the at least one cross section of the bent portion A, and by providing a portion where a load of inrush power is liable to be concentrated besides the outer side (A2′ side) of the bent portion A in the vicinity of the center of the curve in cross section of the bent portion A (the area in the vicinity of a cross section taken along the line A2-A2′ shown in FIG. 2) on which a load of inrush power is liable to be concentrated, a load of inrush power can be dispersed to other portions from the outer side (A2′ side) of the bent portion A in the vicinity of the center of the curve (the area in the vicinity of the cross section taken along the line A2-A2′ shown in FIG. 2). To be more specific, by setting a position of the major axis such that inrush power is dispersed from the outer side (A2′ side) of the bent portion A in the vicinity of the center of the curve (the area in the vicinity of a cross section taken along the line A2-A2′ shown in FIG. 2) thus dispersing a load of inrush power from the outer side (A2′ side) of the bent portion A in the vicinity of the center of the curve in cross section of the bent portion A (the area in the vicinity of a cross section taken along the line A2-A2′ shown in FIG. 2) to an area in the vicinity of an outer periphery in a major axis side, the generation of microcracks on the bent portion A can be suppressed.

Here, it is preferable that, as shown in FIG. 2, the bent portion A of the heater 1 according to the invention is constituted so as to have a cross-sectional shape whose aspect ratio becomes smaller as a distance toward the terminal portion 41 becomes shorter. Due to such a shape, a load of inrush power which is generated at the terminal portion 41 can be gradually dispersed in the direction toward the bent portion A thus further suppressing the generation of microcracks in the bent portion A.

Further, it is preferable that, as shown in FIG. 2, a cross section of the bent portion A of the heater 1 of the invention is a flat shape where the direction perpendicular to a plane parallel to the direction of bending of the bent portion A (a plane including a central axis of the bent portion A) is set as a major axis. Due to such a shape, a load of inrush power which has a tendency that the load is increased on an outer side (A2′ side) of the bent portion A in the vicinity of the center of the bent portion A (in the vicinity of a cross section taken along the line A2-A2′ shown in FIG. 2) can be dispersed into portions in the vicinity of the outer periphery in the directions which are inverted by 90° with respect to the direction of bending (the outer side of the bent portion A) and hence, heat is further dispersed so that heat is not accumulated in the bent portion A whereby the generation of microcracks on the bent portion A can be further suppressed.

Further, in the heater 1 of the invention, it is preferable that, as shown in FIG. 2, a cross section of the bent portion A has an elliptical shape. Due to such a shape, the cross section has no corners so that stress is easily dispersed and hence, microcracks are hardly generated.

Further, in the heater 1 of the invention, it is preferable that, as shown in FIG. 2, the terminal portion 41 has a circular shape. Due to such a shape, inrush stress at the terminal portion 41 can be dispersed uniformly and hence, microcracks are hardly generated.

Further, it is preferable that, in the heater 1 of the invention, the bent portion A has a portion whose aspect ratio is continuously changed as viewed in cross section. Particularly, it is preferable that an aspect ratio is continuously changed over the whole bent portion A as viewed in cross section. Due to such a shape, the heater 1 has no portion on which load is concentrated when the heater 1 takes a steady state and hence, even when the heater 1 is repeatedly used, microcracks are hardly generated.

Further, in the heater 1 of the invention, it is preferable that the bent portion A is constituted so as to have a major axis and a minor axis in any cross sections, and the major axes are in the same direction over the whole of the bent portion A. In other words, it is preferable that the bent portion A is constituted so as to have a major axis and a minor axis in any cross sections, and a length of the major axis becomes shorter and a length of the minor axis becomes longer as a distance toward the terminal portion 41 becomes shorter. Due to such a shape, there arises no change in a load of inrush power and hence, there is no stress concentration generated by torsion whereby microcracks are hardly generated.

The heater 1 is not limited to the constitution shown in FIG. 2 where the terminal portion 41 has a circular shape and the bent portion A has an elliptical shape in cross section, and the heater 1 may have other constitutions. As other constitutions, from a viewpoint of the easiness in forming the heater 1, a relatively simple shape such as a rectangular shape, a rhomboid shape, a triangular shape, a hexagonal shape or an octagonal shape can be named, for example, as the shapes of the terminal portion 41 and the bent portion A. Even when the terminal portion 41 and the bent portion A adopt such a cross-sectional shape, provided that a large aspect ratio is ensured at the bent portion A, it is possible to provide portions on which a load is liable to be concentrated in shape besides the outer side of the bent portion A in the vicinity of the center of the bent portion A so that the load can be dispersed.

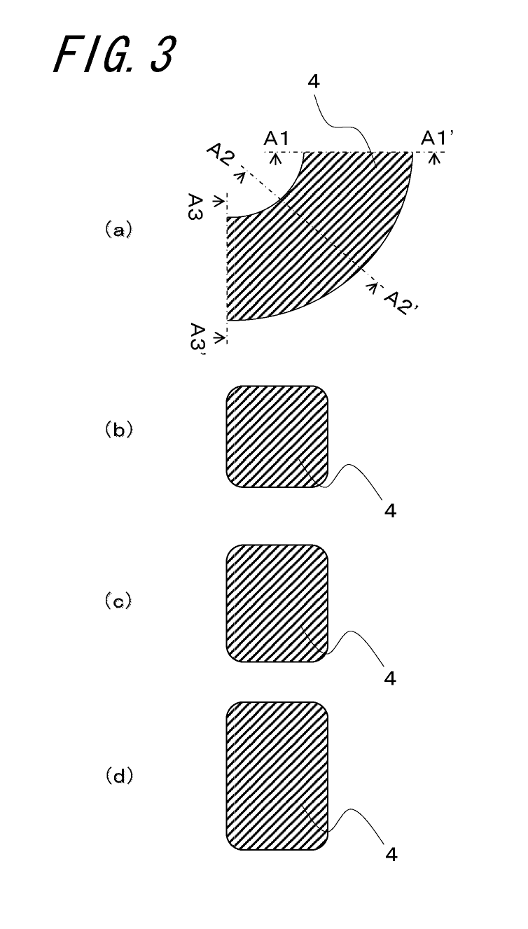

In the constitution where a cross-sectional shape of the lead 4 is changed from a circular shape to an elliptical shape in the direction toward the bent portion A from the terminal portion 41 as shown in FIG. 2, a load is liable to be concentrated on end portions of the bent portion A in the major axis direction of the elliptical shape. In the same manner as the above-mentioned case, in the constitution where both the terminal portion 41 and the bent portion A have a rectangular shape in cross section as shown in FIG. 3 and an aspect ratio becomes larger toward the bent portion A from the terminal portion 41, upper and lower sides become short sides, and with respect to a distance between corner portions where a load is liable to be concentrated, the distance along a short side is smaller than the distance along a long side and hence, the load is liable to be concentrated on the short sides, that is, upper and lower sides.

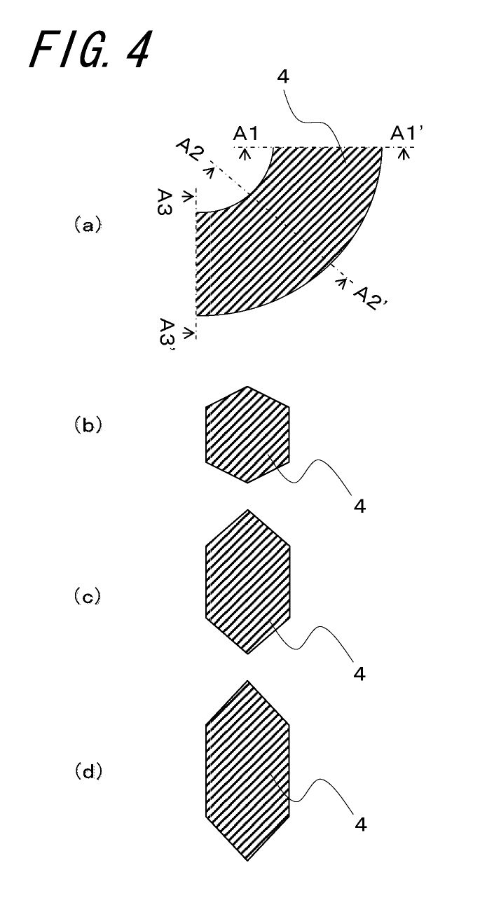

Further, in the case where a cross-sectional shape is a polygonal shape other than a rectangular shape, as shown in FIG. 4, when an aspect ratio becomes larger toward the bent portion A from the terminal portion 41, an angle of upper and lower corner portions becomes smaller or a distance between upper corners and a distance between lower corners become shorter in the same manner as the case where a cross-sectional shape is a rectangular shape and hence, a load is liable to be concentrated on upper and lower sides.

Here, when a cross-sectional shape is a polygonal shape such as the above-mentioned rectangular shape or a hexagonal shape, due to the presence of corner portions, a load is excessively concentrated on the corner portions, or the corner portions are liable to become initiation points of cracks on the insulating base body 2 and hence, it is preferable that the cross-sectional shape is a shape where corner portions are rounded as shown in FIG. 3. In view of the above, a circular shape and an elliptical shape have no such corner portions and hence, these shapes are more preferable.

The above-mentioned heater 1 can be used for a glow plug (not shown). That is, the glow plug (not shown) of the invention includes the above-mentioned heater 1, and a metal holder (a sheath fitting) which is electrically connected to the terminal portion 41 of the lead 4 which constitutes the heater 1 and holds the heater 1. Due to such a constitution, microcracks are hardly generated on the bent portion A of the heater 1 and hence, it is possible to realize a glow plug which can be used for a long period.

Next, one example of a method of manufacturing the heater 1 according to this embodiment is explained.

The heater 1 according to this embodiment can be formed by injection molding or the like which uses molds having shapes of the resistor 3, the lead 4 and the insulating base body 2 having the constitutions according to the above-mentioned embodiment respectively, for example.

Firstly, a conductive paste which contains conductive ceramic powder, a resin binder and the like and is used for forming the resistor 3 and the leads 4 is prepared, and also a ceramic paste which contains insulating ceramic powder, a resin binder and the like and is used for forming the insulating base body 2 is prepared.

Next, a formed body made of a conductive paste having a predetermined pattern for forming the resistor 3 (formed body a) is formed by injection molding or the like using the conductive paste. In a state where the formed body a is held in the inside of a mold, the conductive paste is filled into the inside of the mold thus forming a formed body made of a conductive paste having a predetermined pattern for forming the leads 4 (formed body b). Accordingly, the formed body a and the formed body b which is connected to the formed body a are brought into a state where the formed bodies a, b are held in the mold.

Next, in a state where the formed body a and the formed body b are held in the mold, a portion of the mold is exchanged with a mold for molding the insulating base body 2 and, thereafter, a ceramic paste for forming the insulating base body 2 is filled into the mold. Due to such steps, a formed body of the heater 1 (formed body d) where the formed body a and the formed body b are covered with a formed body made of the ceramic paste (formed body c) is obtained.

Next, by firing the obtained formed body d at a temperature of 1600° C. to 1800° C. under pressure of 30 MPa to 50 MPa, the heater 1 can be manufactured. Here, it is preferable to perform firing in an atmosphere of a non-oxidizing gas such as a hydrogen gas.

### EXAMPLES

The heater according to an example of the invention was prepared as follows.

Firstly, a formed body a for forming the resistor having a shape shown in FIG. 1 was prepared by molding a conductive paste containing 50 mass % of tungsten carbide (WC) powder, 35 mass % of silicon nitride (Si₃N₄) powder and 15 mass % of resin binder in a mold by injection molding.

Next, in a state where the formed body a was held in the inside of the mold, the above-mentioned conductive paste for forming the leads was filled into the mold, thus forming a formed body b for forming the leads having a shape shown in FIGS. 1 and 2 in a state where the formed body b was connected to the formed body a.

Next, in a state where the formed body a and the formed body b were held in the mold, a ceramic paste containing 85 mass % of silicon nitride (Si₃N₄) powder, 10 mass % of oxide of ytterbium (Yb) (Yb₂O₃) which constitutes a sintering aid, and 5 mass % of tungsten carbide (WC) for making a thermal expansion coefficient of the insulating base body approximate a thermal expansion coefficient of the resistor and a thermal expansion coefficient of the lead was filled into a mold by injection molding. Due to such a step, a formed body d where the formed body a and the formed body b were embedded in the formed body c which constitutes the insulating base body was formed.

Next, the obtained formed body d was put into a cylindrical mold made of carbon and, thereafter, the formed body d was sintered by hot-pressing in a non-oxidizing gas atmosphere made of a nitrogen gas at a temperature of 1700° C. and under pressure of 30 MPa, thus manufacturing the heater according to the example of the invention. With respect to this heater (a sample according to the example of the invention), a lead portion included a bent portion, and a shape of the bent portion was changed in the direction toward a terminal portion. A cross section of the bent portion in the vicinity of the center of a curve had a flat shape (an elliptical shape), the terminal portion had a circular shape, a cross-sectional area of the bent portion was constant, an aspect ratio was gradually changed, and the major axis direction of the cross section was always constant.

A glow plug was manufactured by joining a cylindrical metal holder to a lead end portion (terminal portion) which was exposed from a side surface of the obtained heater at a position close to a rear end of the heater by brazing.

On the other hand, as a comparative example, a glow plug having a circular shape in cross section and having a constant aspect ratio over the whole bent portion whose aspect ratio in cross section of the bent portion is equal to an aspect ratio in another cross section of the bent portion, the another cross section being positioned closer to a terminal portion than the at least one cross section of the bent portion was also manufactured.

A thermal cycle test was performed using these glow plugs. As conditions of the thermal cycle test, firstly, the heater was energized and an applied voltage was set such that a temperature of the resistor becomes 1400° C., and the thermal cycle test was repeated 10,000 cycles with 1 cycle being constituted of (1) energization for 5 minutes and (2) non-energization for 2 minutes.

A change in a resistance value of the heater before and after the thermal cycle test was measured. With respect to the sample according to the example of the invention, the change in a resistance value was 1% or less. Further, there is no trace of the generation of local heating on an interface between the lead and the insulating base body of the sample, and no microcracks were visually recognized on the interface. To the contrary, with respect to a sample according to the comparative example, a change in a resistance was 5% or more, and microcracks were visually recognized on the interface.

### REFERENCE SIGNS LIST

1: Heater
2: Insulating base body
3: Resistor
31: Heat-generating portion
4: Lead
41: Terminal portion
A: Bent portion

1. A heater, comprising:
an insulating base body;
a resistor embedded in the insulating base body; and
a lead embedded in the insulating base body and comprising one end connected to the resistor, and a terminal portion at another end thereof which is exposed from a surface of the insulating base body, wherein
the lead further comprises a bent portion bent toward the terminal portion, an aspect ratio in at least one cross section of the bent portion being larger than an aspect ratio in another cross section of the bent portion, the another cross section being positioned closer to the terminal portion than the at least one cross section of the bent portion.

2. The heater according to claim 1, wherein
an aspect ratio in a cross section of the bent portion becomes smaller as a distance toward the terminal portion becomes shorter.

3. The heater according to claim 1, wherein
a cross section of the bent portion has a flat shape comprising a major axis extending along a direction perpendicular to a direction of bending of the bent portion.

4. The heater according to claim 1, wherein
a cross section of the bent portion has an elliptical shape.

5. The heater according to claim 1, wherein
the terminal portion has a circular shape.

6. The heater according to claim 1, wherein
the bent portion comprises a portion whose aspect ratio is continuously changed as viewed in cross section.

7. The heater according to claim 1, wherein
the bent portion is constituted so as to comprise a major axis and a minor axis in any cross sections, and the major axes are in a same direction over a whole of the bent portion.

8. A glow plug, comprising:
the heater according to claim 1; and
a metal holder which is electrically connected to the terminal portion of the lead and holds the heater.
